(19) United States
(12) Patent Application Publication
(10) Pub. No.: US 2010/0039522 A1
(43) Pub. Date: Feb. 18, 2010

(54) DIGITAL IMAGE CAPTURE DEVICE CAPABLE OF DETERMINING DESIRED EXPOSURE SETTINGS AND EXPOSURE METHOD THEREOF

(75) Inventor: CHUN-CHIEH HUANG, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/346,889

(22) Filed: Dec. 31, 2008

(30) Foreign Application Priority Data
Aug. 14, 2008 (CN) 200810303770.8

(51) Int. Cl. H04N 5/228; G03B 7/00

(52) U.S. Cl. 348/222.1; 396/213; 348/E05.031

(57) ABSTRACT

An exposure method is disclosed. An image is captured using current exposure settings. The image is displayed on a screen which is subdivided into several areas to provide judgement of whether the current exposure settings are desired or not and allow determination of adjustment of metering weights for the areas if the current exposure settings are not desired. The adjustment of the metering weights for the areas is carried out based upon the determination. Light in the scene is measured based upon using the adjusted metering weights. New exposure settings are calculated based upon the measurement of light. The above steps are circled through until a desired exposure has been obtained.

### BACKGROUND

1. Technical Field

The present disclosure relates to a digital image capture device which can determine desired exposure settings and an exposure method thereof.

2. Description of the Related Art

In general, digital image capture devices typically include an auto-exposure system which is capable of measuring the amount of light in the scene and automatically determining exposure settings based upon the measurement. Many metering techniques have been proposed for the measurement, such as matrix metering, center-weighted metering, and spot metering. Most of the time, the auto-exposure system works well. However, it may also behave very foolish since the measurement works based upon certain assumptions that do not always perfectly match with the scene. For example, the commonly used center-weighted metering assumes that the center of the scene is where an object of interest is located and accordingly averages the exposure settings for the entire scene but gives extra weight to the center. This center-weighted metering may work well enough for taking portrait but not for taking images where an object of interest is not well centered in the scene.

Therefore, it is desirable to provide a digital image capture device and an exposure method thereof, which can overcome the above-mentioned problems.

### BRIEF DESCRIPTION OF THE DRAWINGS

FIG. 1 is a block diagram of a digital image capture device, according to an exemplary embodiment.

FIG. 2 is a schematic view showing the back of the digital image capture device of FIG. 1.

FIG. 3 is a flowchart of an exposure method, according to another exemplary embodiment.

### DETAILED DESCRIPTION OF THE EMBODIMENTS

Embodiments of the digital image capture device and exposure method will now be described in detail with reference to the accompanying drawings. In the following described embodiments, the digital image capture device can be, but is not limited to, a digital still camera or a mobile phone equipped with a camera module.

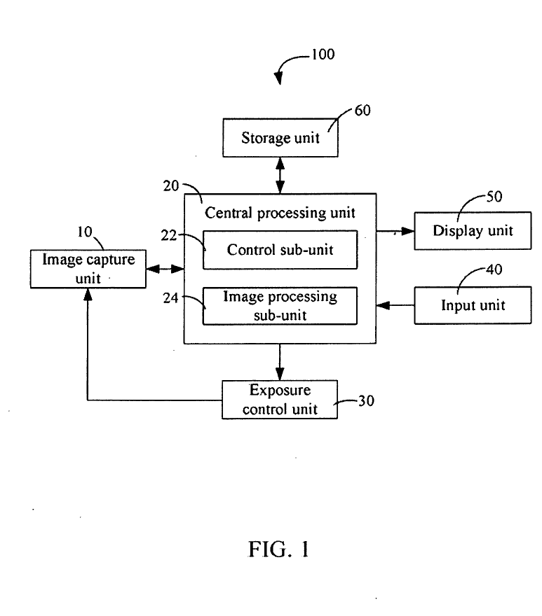

Referring to FIG. 1, a digital image capture device 100 includes an image capture unit 10, a central processing unit (CPU) 20, an exposure control unit 30, an input unit 40, a display unit 50, and a storage unit 60.

The image capture unit 10 is configured for capturing image signals using determined exposure settings.

The CPU 20 includes a control sub-unit 22 and an image processing sub-unit 24. The control sub-unit 22 is configured for coordinating the image capture unit 10, the image processing sub-unit 24, the exposure control unit 30, the input unit 40, the display unit 50, and the storage unit 60. The image processing sub-unit 24 is configured for processing the captured image signals from the image capture unit 10 and outputting corresponding preview images.

The exposure control unit 30 is configured for determining the exposure settings in response to user input.

The input unit 40 is configured for receiving the user input. The display unit 50 is configured for displaying the preview images.

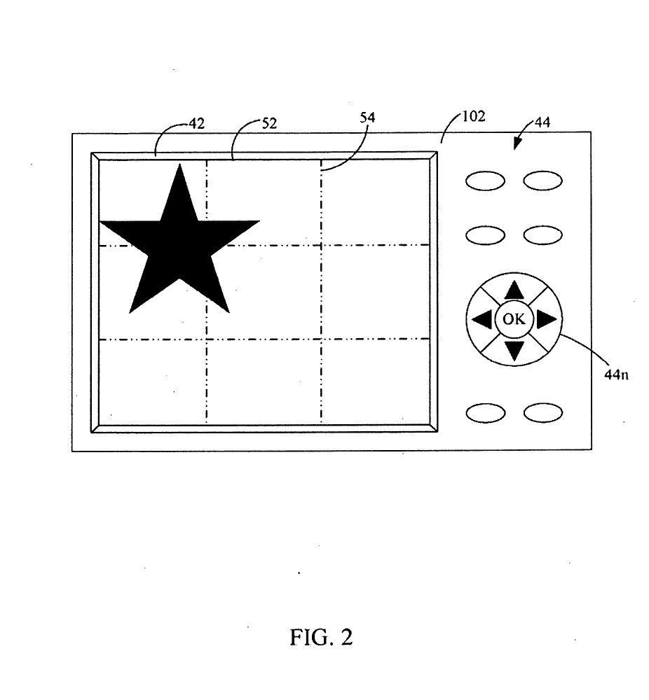

Also referring to FIG. 2, in this embodiment, the input unit 40 and the display unit 50 are installed on the back 102 of the digital image capture device 100 and constitute a user interface which may include a touch screen 42 and a keypad 44. It should be mentioned that the user interface is not limited to this embodiment, and can take other configurations in other alternative embodiments. For example, the touch screen 42 can be simplified to a display panel and the user input function is performed using the keypad 44, or the keypad 44 is omitted and the input function is carried out by using the touch screen 42.

The control sub-unit 22 is also configured for subdividing the screen 52 of the display unit 50 into several areas using help lines 54. Exposure settings can be adjusted according to input regarding one or more of the subdivisions of the screen 52. In detail, when a current preview image is displayed by the display unit 50, the user can elect to adjust metering weights of one or more of the subdivisions. Then, the exposure control unit 30 can measure light in the scene using the metering weights, calculate new exposure settings, and cause a new preview image to be captured using the new exposure settings. Then the new preview image is displayed by the display unit 50 to allow the user to make further adjustments to the metering weights or except that the new exposure setting is accepted.

For example, in this embodiment, the screen 52 is subdivided into a 3×3 matrix of areas. The object is a black star in the top-left corner of the image. Accordingly, the user may decide and give high metering weight to the top-left area, low metering weight to the areas surrounding the top-left area, and zero metering weight to the remaining areas to obtain exposure settings that will give best exposure to light from the black star. In operation, the user can select an area by clicking a corresponding region of the touch screen 42 and adjust the metering weight of that area via a navigation key 44n of the keypad 44. For example, depressing the upper/bottom button of the navigation key 44n increases/decreases that metering weight. Depressing “OK” button of the navigation key 44n confirms the adjustment of the input of that metering weight.

In other alternative embodiments, the storage unit 60 can store groups of metering weights. Then, the user can select one group from a menu provided on the screen 52 according to where an object of interest in located in view of the screen 52.

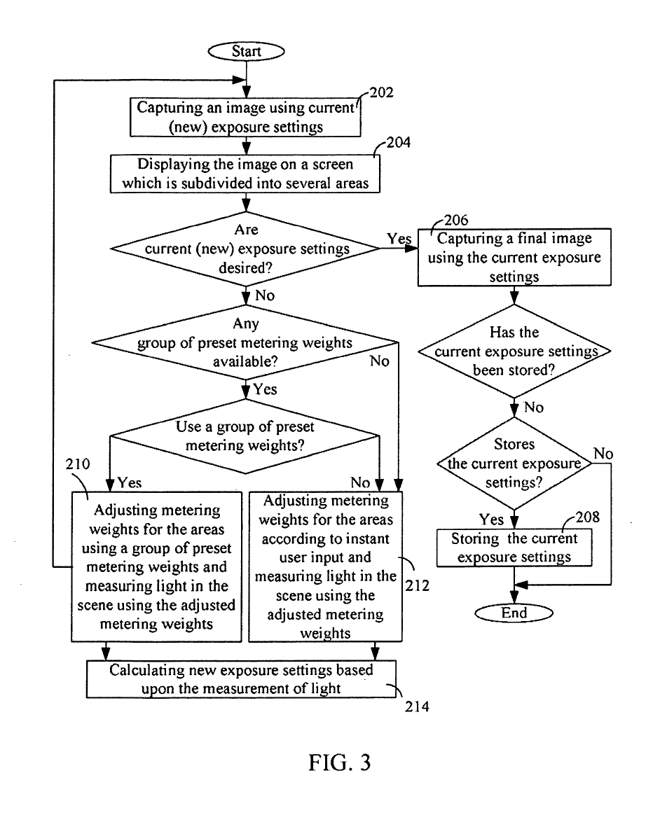

Also referring to FIG. 3, an exposure method in accordance with another exemplary embodiment can be implemented by the digital image capture device 100 and includes the following steps S202-S214.

Step 202: capturing a preview image using current exposure settings. This step can be carried out by the image capture unit 10 and the image processing sub-unit 24. In detail, the current exposure settings can be default exposure settings stored in the storage unit 60 if current captured preview image is the initial image after the digital image capture device 100 is powered on. Otherwise, the current exposure settings are determined by the exposure control unit 30 based upon measurement of light in the scene (see above and below). In practice, what the image capture unit 10 really produces is image signals. These image signals need to be processed by the image processing sub-unit 24 to output the current preview image.

Step 204: displaying the current preview image on the screen 52 which is subdivided into several areas to allow judgement of whether the current exposure settings are desired. This can be carried out by and the display unit 50 and the control sub-unit 22. In this embodiment, the screen 52 is subdivided into a 3×3 matrix of areas.

Step 206: capturing a final image using the current exposure settings if the current exposure settings are desired. This can be carried out by the image capture unit 10. In detail, if the exposure settings are desired, the current exposure settings are locked and used by the image capture unit 10 to capture the final image. The current exposure settings may be suitable for other circumstances too. Therefore, the user can check whether the current exposure settings have been stored in the storage unit 60. If no, the user can elect to store the current exposure settings.

Step 208: storing the current exposure settings. This step can be carried out by the storage unit 60.

Step 210: receiving a group of preset metering weights and measuring light in the scene if the current exposure settings are not desired. This step can be carried out by the exposure control unit 30. In operation, if the current exposure settings are not desired, the user can check whether any group of preset metering weights for the subdivided areas is stored in the storage unit 60. If yes, the user can elect to use one group of preset metering weights. If yes, then step 210 is carried out. If no, go to step 212.

S212: receiving metering weights according instant input and measuring light in the scene if the current exposure settings are not desired. This step can be finished by the exposure control unit 30 (see above).

S214: calculating new exposure settings based upon the measurement light in the scene of step 210 or step 212. This step is also carried out by the exposure control unit 30. Then, the flow of the exposure method goes back to step 202 and applied the new exposure settings to the image capture unit 10 to capture a new preview image for further judgement of whether the new exposure settings are desired or not. The exposure method loops through step 202, 204, 210/212 and 214 until a desired exposure value is obtained.

It will be understood that the above particular embodiments and methods are shown and described by way of illustration only. The principles and the features of the present invention may be employed in various and numerous embodiments thereof without departing from the scope of the invention as claimed. The above-described embodiments illustrate the scope of the invention but do not restrict the scope of the invention.

What is claimed is:

1. A digital image capture device comprising:
an image capture unit for capturing an image using current exposure settings;
a display unit for displaying the image to allow judgement of whether the current exposure settings are desired;
an input unit for receiving a user input;
a central processing unit comprising:
a control sub-unit configured for subdividing the screen of the display unit into a plurality of areas to allow determination of adjustment of metering weights fore the area if the current exposure settings are not desired;
an exposure control unit configured for measuring light in the scene using the metering weights and calculating exposure settings based upon the measurement of light.

2. The digital image capture device as claimed in claim 1, wherein the control sub-unit is configured for coordinating the image capture unit, the display unit, the input unit, and the exposure control unit.

3. The digital image capture device as claimed in claim 1, wherein the central processing unit further comprises an image processing sub-unit for processing the image captured by the image capture unit so that the image is displayable by the display unit.

4. The digital image capture device as claimed in claim 1, wherein the display unit and the input unit are integrated into a touch screen.

5. The digital image capture device as claimed in claim 1, wherein the input unit comprises a keypad.

6. The digital captured device as claimed in claim 1, wherein the display unit and the input unit are integrated into a touch screen and a keypad, the touch screen is configured for selecting an area whose metering weight is required to be adjusted, the keypad comprising a navigation key which is configured for adjusting the metering weight of the selected area.

7. The digital image capture device as claimed in claim 1, wherein the control sub-unit subdivide the screen of the display unit using help lines.

8. The digital image capture device as claimed in claim 1, further comprising a storage unit, the storage unit being configured for storing a group of metering weights for the areas.

9. An exposure method:
capturing an image using current exposure settings;
displaying the image on a screen which is subdivided into several areas to provide judgement of whether the current exposure settings are desired and allow determination of adjustment of metering weights for the areas if the current exposure settings are not desired;
adjusting the metering weights for the areas based upon the determination;
measuring light in the scene using the adjusted metering weights; and
calculating new exposure settings based upon the measurement.

10. The exposure method as claimed in claim 9, further comprising:
capturing a final image using the current exposure settings if the current exposure settings are desired.

11. The exposure method as claimed in claim 9, further comprising:
storing the current exposure settings if the current exposure settings are desired to be stored and used in other circumstances.

12. The exposure method as claimed in claim 9, wherein the screen is subdivided using help lines.

13. The exposure method as claimed in claim 9, wherein the metering weights are adjusted by receiving a group of preset metering weights from a storage unit.

14. The exposure method as claimed in claim 9, wherein the metering weights are adjusted by instant user input.

15. The exposure method as claimed in claim 9, wherein the metering weights are adjusted by the steps of:
selecting an area whose metering weight is required to be adjusted; and
adjusting the metering weight of the selected area.

16. The exposure method as claimed in claim 15, wherein the area is selected using a touch screen.

17. The exposure method as claimed in claim 15, wherein the metering weight is adjusted using a navigation key.

18. The exposure method as claimed in claim 9, further comprising:
capturing another image using the new exposure settings, which is displayed for further judgement of whether the new exposure settings are desired and further determination of adjustment of metering weights for the areas if the new exposure settings are still not desired.
